(19) United States
(12) Patent Application Publication
(10) Pub. No.: US 2017/0259611 A1
(43) Pub. Date: Sep. 14, 2017

(54) BINDER CLIP WITH WRITABLE SURFACE

(71) Applicant: Marivé King, Naples, FL (US)

(72) Inventor: Marivé King, Naples, FL (US)

(21) Appl. No.: 15/067,635

(22) Filed: Mar. 11, 2016

(51) Int. Cl. B42F 1/00; G09F 3/02; G09F 23/00

(52) U.S. Cl. CPC B42F 1/006; G09F 23/00; G09F 3/02

(57) ABSTRACT

A binder clip (1) having an outer surface (5) capable of retaining an applied writing medium (16), such as ink, graphite and the like for use in marking with indicia (17) to identify materials to be held within the binder clip.

### FIELD OF THE INVENTION

This invention relates to clips used for binding stacks of paper and documents together and more particularly a binder clip having a writeable outer surface to allow users to write indentifying indicia on the outer surface of the clip so that the bound documents may be easily organized, stored and quickly identified. In addition, the binding clip of the present invention may be used to secure, organize and/or label numerous objects other that paper, such as garments, clothes, keys, photos, wrapping paper, carrying bags, storage bags and so forth.

### BACKGROUND OF THE INVENTION

A binder clip is a device commonly used for binding sheets of paper together. It leaves the paper intact without causing damage to the paper, unlike staples.

A binder clip is a strip of spring steel bent into the shape of an isosceles triangle with loops at the apex. Tension along a base of the triangle forces the two sides closed, and the loops prevent the sharp steel edges from cutting into the paper. The loops also serve to hold two pieces of stiff wire, which are used as handles and allow the clip to be opened. The two slots cut in each loop are shaped so that the wire handles can be folded down once the clip has been attached, and the spring force of the wire holds them down on the surface of the paper. This holds the clip relatively flat, for easier stacking of paper. The handles can also be removed altogether by squeezing them sideways and pulling them out, allowing for more permanent binding.

While binder clips are commonly used to organize and store stacks of paper, they have not been commonly used to label and/or identify the stacks of paper being bound. This is due to the fact that the metal used to make conventional binder clips does not accept ink or graphite from writing instruments. Therefore, past means for labeling a binder clip required the use of a label and mechanical attachment or adhesive to secure the label to the binder clip, which overcomplicates the labeling process, thereby making it undesirable.

Therefore, a need exists for a binder clip having a writeable outer surface to allow users to write indentifying indicia directly on the clip using conventional writing instruments so that the bound documents may be easily organized, stored and quickly identified.

The relevant prior art includes the following references:

| Pat. No. | Inventor | Issue/Publication Date |
|---|---|---|
| 1,133,388 | Merrill | Mar. 20, 1915 |
| 2001/0032376 | Payne | Oct. 21, 2001 |
| 7,318,293 | Adern | Jan. 15, 2008 |
| 7,730,593 | Juilly | Jun. 8, 2010 |
| 7,992,260 | Juilly | Aug. 9, 2011 |
| CN103692813 | N/A | Apr. 2, 2014 |
| 9,044,992 | Miller | Jun. 2, 2015 |

### SUMMARY OF THE INVENTION

The primary object of the present invention is to provide a binder clip having a writeable outer surface to allow users to write indentifying indicia directly on the clip using conventional writing instruments so that the bound documents may be easily organized, stored and quickly identified.

An additional object of the present invention is to provide a binder clip that may be used to secure, organize and/or label numerous objects other that paper, such as garments, clothes, keys, photos, wrapping paper, carrying bags, storage bags and so forth.

The present invention fulfills the above and other objects by providing a binder clip having an outer surface capable of retaining an applied writing medium, such as ink, graphite and the like. The writeable surface preferably prevents the writing medium that has been written onto it from smudging or smearing after the substance has dried.

The writeable surface or substrate, which may be a writeable paint or equivalent substance that retains ink or graphite, is preferably porous in order to retain ink or other mediums. The writeable surface may be textured, have a matte finish or other non-glossy surface that will hold and retain the writing medium being used. The writeable surface may be a lighter color to allow for a contrast between the binder clip and the writing medium being used.

The inner surface of the binder clip preferably has a smooth non-writeable surface to allow the binder clip to slide onto the paper being bound. This ensures that the inner surface of the binder clip will not damage the paper by scraping the paper with a porous textured writeable surface as the outer writeable surface may be abrasive to the paper being bound.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective side view of a binder clip of the present invention;

FIG. 2 is a side sectional view along lines 2-2 of FIG. 1 of a binder clip of the present invention; and

FIG. 3 is a side view a plurality of stacks of paper each bound together with a binding clip of the present invention.

### DESCRIPTION OF THE PREFERRED EMBODIMENTS

For purposes of describing the preferred embodiment, the terminology used in reference to the numbered components in the drawings is as follows:
1. binder clip, generally
2. main body
3. loop
4. apex
5. outer surface of main body
6. stack of paper
7. inner surface of main body
8. base of main body
9A. side of main body
9B. upper edge of side of main body
10. handle
11. slot
12. writable surface
13. substrate
14. writeable paint
15. non-glossy finish
16. writing medium
17. indicia
18. non-writeable surface
19. glossy finish
20. smooth finish

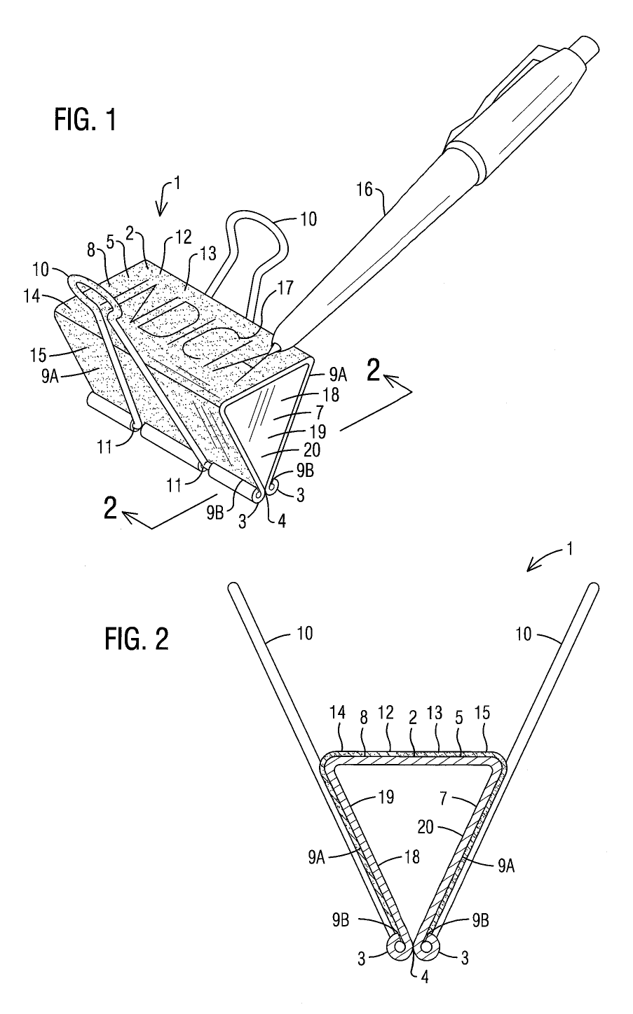

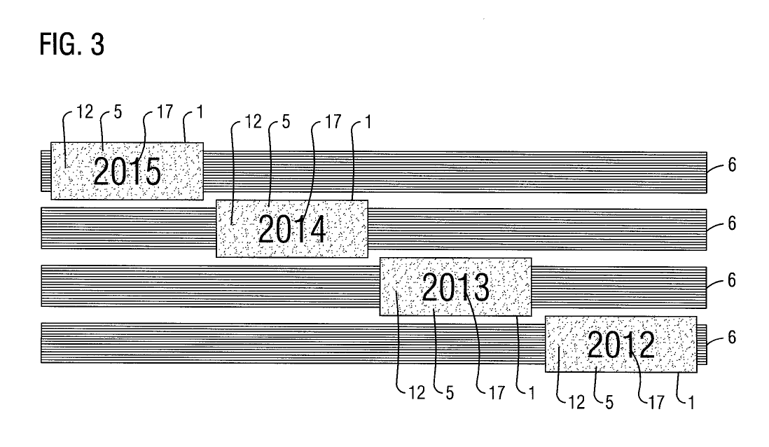

With reference to FIGS. 1-3, the binder clip 1 comprises a main body 2, which may be formed out of a strip of spring steel, plastic or so forth, bent into the shape of an isosceles triangle with loops 3 located at an apex 4. The main body 2 further comprises an outer surface 5 that is visible when the binder clip 1 is placed on a stack of paper 6, as illustrated in

FIG. 3, and an inner surface 7 that makes contact with the paper 6 being bound. Tension along a base 8 of the triangle-shaped main body 2 forces two opposing sides 9A with upper edges 9B closed, and the loops 3 prevent any sharp edges from cutting into the paper 6. The loops 3 also serve to hold two handles 10 used to open the binder clip 1. Two slots 11 cut in each loop 3 are preferably shaped so that the handles 10 may be folded down flat after the binder clip 1 has been attached to a stack of paper 6. The main body 2 illustrated herein is triangular-shaped, however, the main body 2 may also be circular-shaped.

The outer surface 5 of the binder clip 1 comprises writeable surface 12 or substrate 13 located thereon. The substrate 13 is preferably a writeable paint 14 having a porous texture, matte finish or similar non-glossy finish 15 or liquid paper that is capable of retaining ink or other writing mediums 16, such as graphite, so that indicia 17 may be written on the outer surface of the binder clip 1. The writeable surface 12 may be a lighter color to allow for a contrast between the binder clip 1 and the writing medium being used. The substrate 13 or writeable paint 14 may be applied to the outer surface 5 of the binder clip 1 prior to the main body 2 being cut and formed into a triangular shape or after the forming process using convention spraying methods and/or electrostatic painting. Bound documents may be easily organized, stored and quickly identified using the binding clip 1 of the present invention, as illustrated in FIG. 3 which shows several stacks of paper 6 that are each identified by a particular year. The writeable surface 12 is preferably located on the entire outer surface 5 of the binder clip 1 including the outer surface of the base 8 of the triangle-shaped main body 2 and two opposing sides 9A.

The inner surface 7 of the binder clip 1 preferably has a smooth non-writeable surface 18 to allow the binder clip 1 to slide onto the paper 6 being bound. This non-writeable surface 18 is preferably a glossy finish 19 or a smooth finish 20 to ensure that the inner surface 7 of the binder clip 1 will not damage the paper 6 by scraping the paper 6 with a porous textured writeable surface 12 as the outer surface 5 has, which may be abrasive to the paper 6 being bound.

It is to be understood that while a preferred embodiment of the invention is illustrated, it is not to be limited to the specific form or arrangement of parts herein described and shown.

It will be apparent to those skilled in the art that various changes may be made without departing from the scope of the invention and the invention is not to be considered limited to what is shown and described in the specification and drawings.

Having thus described my invention, I claim:

1. A binder clip comprising:
a main body having an outer surface and an inner surface;
said main body having a base and two opposing sides with upper edges held together by tension;
handles located on the upper edges of the opposing sides; and
said outer surface having a writeable surface capable of retaining a writing medium.

2. The binder clip of claim 1 wherein:
said writeable surface is a porous substrate located on the outer surface of the main body.

3. The binder clip of claim 1 wherein:
said writeable surface is a writeable paint applied to the outer surface of the main body.

4. The binder clip of claim 3 wherein:
said writeable paint is a paint having a matte finish.

5. The binder clip of claim 3 wherein:
said writeable paint is a paint having a non-glossy finish.

6. The binder clip of claim 1 wherein:
said inner surface of the main body is a non-writeable surface.

7. The binder clip of claim 2 wherein:
said inner surface of the main body is a smooth non-porous surface.

8. The binder clip of claim 4 wherein:
said inner surface of the main body is a smooth surface.

9. The binder clip of claim 5 wherein:
said inner surface of the main body is a smooth surface.

10. A binder clip comprising:
a main body having an outer surface and an inner surface;
said main body having a base and two opposing sides with upper edges held together by tension;
handles located on the upper edges of the opposing sides;
said outer surface having a writeable surface capable of retaining a writing medium; and
said inner surface of the main body is a non-writeable surface.

11. The binder clip of claim 10 wherein:
said writeable surface is a porous substrate located on the outer surface of the main body.

12. The binder clip of claim 10 wherein:
said writeable surface is a writeable paint applied to the outer surface of the main body.

13. The binder clip of claim 12 wherein:
said writeable paint is a paint having a matte finish.

14. The binder clip of claim 12 wherein:
said writeable paint is a paint having a non-glossy finish.

15. The binder clip of claim 10 wherein:
said inner surface of the main body is a smooth surface.

16. The binder clip of claim 10 wherein:
said inner surface of the main body is a smooth surface.
